(19) United States
(12) Patent Application Publication
(10) Pub. No.: US 2019/0308071 A1
(43) Pub. Date: Oct. 10, 2019

(54) Intelligent Fitness

(71) Applicant: Hermann Makayeu Diety, Abidjan (CI)

(72) Inventor: Hermann Makayeu Diety, Abidjan (CI)

(21) Appl. No.: 15/932,689

(22) Filed: Apr. 10, 2018

(51) Int. Cl. A63B 24/00; A63B 71/00; A63B 23/12; G05B 19/4155

(52) U.S. Cl. CPC A63B 24/0087; A63B 71/0054; A63B 24/0062; A63B 23/1209; A63B 2023/0411; A63B 2071/0081; A63B 2220/20; A63B 2220/52; A63B 2220/833; G05B 19/4155

(57) ABSTRACT

This method creates a safer exercise environment with a modern technology that does not alter the tradition of mechanical training, yet provides the gymnasium machines with this intelligent system to prevent injuries. The approach is to equip the exercise machines with a way of analyzing its user performance as long as he works out, by the continual collection of data from various sensors after the user personalized the gymnasium equipment, these data are used as a basis for servo system to give the appropriate set of instructions through some written programs to guide the step motor and the piezoelectric bore to control that exercise equipment in order to prevent said accidents whenever there is said sudden failure from the user's muscle.

### TECHNICAL FIELD

The invention pertains specifically to a mechatronics system. More specifically, the system is meant to protect bodybuilders from injuries and other incidents in gymnasium. The concern is how to secure these exercise equipment's users while maintaining the authenticity of the training tradition. Unlike the bicycle that does not have much history of harming people, many other machines do. The invention is a combination of a set of sensors, step motor, microcontrollers to build a smart system which will actually protect any bodybuilder while not hindering their training. We start by putting a weight sensor either at the appropriate place on the metal rod of the exercise equipment of interest to measure the mass of the weight's plate selected by users. Similarly, we measure the height from the bar or set of weight's plates of a personalized machine with respect to a certain reference point which could be another part of the machine or the ground on which the machine is fixed, and this measurement is done with the help of a distance sensor. The same proceeding applies for the accelerometer for the estimate of the speed at which a person exercises. On other circumstances, for instance, in the case of the leg press, the angle the seat makes with the horizontal needs to be taken into account for an accurate force estimate. The sensor outputs are conveyed to one of the microcontrollers via the appropriate conditioning circuits. In this particular case, the choice of two microcontrollers seems excellent for a better performance of the servo system. Additionally, we use the step motor to provide the necessary mechanical force to block the bar at the first, and gradually increase the motor output force to further raise the bar to the final position selected by the equipment's user. There will be a low inertia pulley at the end of the pulley to convert the rotational motion of the motor shaft into a translational motion of the training equipment bar or rope. The choice of a piezoelectric bore as an actuator to rotate the bar before the motor releases the load appears adequate. In other words, we are simply monitoring the exercise equipments with a position and a velocity control systems embedded in the appropriate choice of microcontrollers.

The invention possesses numerous advantages over the classical training equipments in gymnasiums. On the electrical side, the maximal output current for this power system will be around 20 A with a maximum voltage of 47 V provided by the power amplifier. The system takes approximately 10 s to raise the bar, but 0.5 second to block the training when the return acceleration is a certain percentage of the forward acceleration of the bar based on the up and down, forward and backward motions the machine's user makes when working out. However, if the accelerometer is inadequate, an experimentally set critical output value of the distance sensor will trigger the emergency system. This will prevent many unnecessary accidents in the case of a sudden muscle failure. The smart system of the present invention, given its ease to implement is ideally suited for the preceding application, wherein flexibility and economy is desired.

The computer feature will have to do with programming the microcontrollers. Specifically, there will be programs for the position control, the velocity profile, PWM, conditioning circuits.

Similarly, the mechanical features of the control system enable it to tolerate more freedom on part of these equipment's users just as if the presence of the control system were unnoticeable. The choice of these components, as previously discussed, liberate it from the specialized installation and maintenance protocols required from other alternatives.

Thus we are securing the exercise equipment users without altering the training's tradition.

### BACKGROUND OF THE ART

The huge range of fitness equipment available today not only fills the floors of health clubs and gyms all over the world but also the showrooms and catalogs of retailers of fitness equipment designed for home use. Evidence of free-weight use exists as far back in history as the ancient Greeks but the earliest examples of the fixed-weight machines we now view as standard fitness equipment can be traced back to the late 19th century.

Resistance Machines

In the 1850s, Swedish physician Dr. Gustav Zander began experimenting with ideas that would lead to the first variable resistance weights machines. He then founded the Zander Institute in Stockholm and equipped it with 27 of his custom-built machines to create the earliest known example of the gym environment we're familiar with today. The success of his equipment led to the opening of a second Zander Institute in London and then in New York in the 1880s. By 1911 there were 202 Zander Institutes around the world and his machines are credited as being the precursors to many pieces of modern fitness equipment. In 1936, Jack LaLanne opened the first modern health studio in America and developed several equipment prototypes including the first leg extension machine, the first cable and pulley machines and the first weight selectors.

Cardiovascular Machines

The first medical treadmill was designed by Dr. Robert Bruce and Wayne Quinton at the University of Washington in 1952. Their design was used to diagnose heart and lung disease but in 1968, Dr. Kenneth Cooper published a book entitled “Aerobics,” which brought the benefits of cardiovascular exercise to a wide audience and prompted the commercial development of treadmills for home use. Around the same time, Keene Dimick, Ph.D., developed the first computerized exercise equipment, and his design became the revolutionary Lifecycle exercise bike in the 1970s. However, the first stationary bike design can be traced back as far as 1796 to an invention named the Gymnasticon created by Francis Lowndes.

Elliptical Machines

In 1995, Precor USA launched the first elliptical trainer. The oval movement of the footplates on an elliptical trainer mimics the natural pattern of foot movements used in running but removes the high impact element and reduces the stress placed on the joints while exercising. A Precor engineer developed the design in response to his daughter's need to continue exercising while recovering from a heel injury. Other manufacturers followed the trend and upper body movements were added to develop the range of exercise machines known as cross-trainers.

Virtual Machines

Advances in computer technology have made “virtual fitness” a reality. The arrival of Nintendo's Wii Fit in 2007 heralded the beginning of a whole new approach to fitness training and changed the profile of fitness machines. Using only a Wii Balance Board and a computer or TV screen, virtual exercisers can take part in over 40 different fitness activities in the comfort of their own home.

### SUMMARY OF INVENTION

### Technical Problems

Exercise equipments have long been known and widely used in society as mentioned above.

According to U.S. Pat. No. 8,167,776 of May 1, 2012:

Regular exercise and physical activity are both important and beneficial for long-term health and well-being. Some of the benefits of exercise and physical activity include a reduced risk of premature death, heart disease, high blood pressure, cholesterol and a reduced risk of developing colon cancer and diabetes. In addition, the benefits of exercise and physical activity further include a reduced body weight, a reduced risk of depression and improve psychological well-being.

As such, various types of exercising equipment are currently known that enable an operator to exercise. Some exercising equipment may require the expertise of an instructor or a personal trainer to teach the operator the proper techniques and usage of the equipment. The user must also remember the required settings for the equipment and understand when these settings should be changed as the physical ability and strength of the user increases. Because of these limitations in order for an individual to properly and effectively use the exercise equipment the supervision of an experienced trainer is often required.

Typical control systems of this type are shown, for example, in the following United States of America patents:

U.S. Pat. No. 8,157,706

U.S. Pat. No. 8,128,535

U.S. Pat. No. 7,988,599

U.S. Pat. No. 7,942,839

U.S. Pat. No. 7,938,752

U.S. Pat. No. 7,862,475

Though such systems have achieved considerable popularity and commercial success, there has been a continuing need for improvement.

### Solution to Problem

Current gymnasium equipments lack the adequate safety system for their users. Therefore, I thought one of the most efficient ways of preventing injury is to make them “smarter” with my invention. This invention in a case of muscle failure will automatically take control over the equipment and bring it to rest.

### Advantageous Effects of Invention

This invention will readily avoid injury when the instructor or the gymnasium staff is not in a position to intervene fast enough to rescue the exercise equipment's user in a case of accident.

### BRIEF DESCRIPTION OF DRAWINGS

FIG. 1 is a diagram of the overall subsystems of the control systems. It shows the different modules that are included in this innovation.

FIG. 2 to FIG. 4 show how the different sensors output signals are conditioned before being carried in the servo system.

FIG. 5 shows the internal features of the servo system

FIG. 6 show the components of a generic sigma and delta used in Analog to Digital converter.

FIG. 7 shows the equivalent circuit of a DC motor employed to choose to determine the Root means square for the right stepper motor and amplification.

FIG. 8 shows the time interval on the trapezoidal velocity profile.

FIG. 9 is a pulse-width modulating signal (PWM)

FIG. 10A is a three-phase VR step motor static curve of phase 1 (a) and periodic torque distribution (b).

FIG. 11 shows a single-step response (a) and corresponding single-phase torque (b), and a typical response in the stepping mode (c)

FIG. 12 shows a typical slewing response

FIG. 13 shows a generic torque model (a) and electromechanical model a step motor (b).

FIG. 14 shows a relation between the starting T_{PI} and running torque ranges

FIG. 15 shows a starting torque curves with and without equivalent load inertia

FIGS. 16 and 17 show how the control system is mounted on some gymnasium equipments.

### DESCRIPTION OF EMBODIMENTS

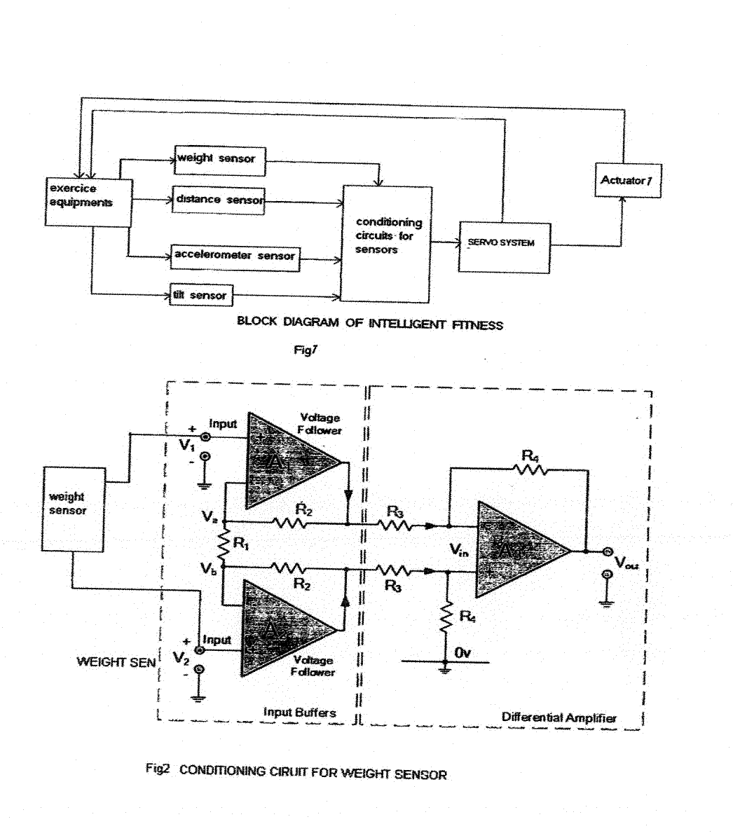

FIG. 1 represents the preferred embodiment of the present invention. By way of an overview, it provides a diagram for the present invention. A step by step explanation appears adequate for an easy understanding of the entire process.
1. As soon as a person personalizes his exercise equipment, that is a selection of the appropriate weight, height of the cross over rope, lap pull down, chest press, leg press, the weight sensor placed at the proper position on these equipments measures the weight, reads the corresponding weight as an output voltage which is conveyed to the servo system, precisely in the IC1 through the conditioning circuit shown (FIG. 2 to FIG. 4). In general the raw electric signal generated by the sensors might not be useful because it may be too small, or noisy, contain wrong information due to poor transducer design or installation, or be incompatible with the input requirements of the processing device, such as the IC1.
2. The signal conditioning in turn carries the final weight sensor data to the Microcontroller (IC1) in the servo system of FIG. 5, which saves it into one of its registers whose values can be altered according to the bodybuilder update of the number of plates that is, when he adds or takes away plates from his exercise equipment. Similar process occurs with the distance sensor as the bodybuilder usually selects the height on the equipment accordingly. So data from the distance sensor is equally saved in one register in IC1. When one of these equipment's user starts his exercise, he pulls and relaxes either the bar of the chest press, the rope of the lap pull down, and pushes back and forth the sheet metal of the hack slide.
3. Experience and attentive observation suggest that when a muscle suddenly fails, there is an abrupt and unintentional release of the cables, bars, sheet plates of these machines. Consequently, the use of a uniaxial accelerometer with an output which has a positive and a negative square wave signals corresponding respectively to the pull (upward and positive by convention) and relaxation (downward and negative by convention), and the consideration of a critical value of the position sensor seem to be an ideal approach of tackling this specific problem.
4. Therefore, data from the accelerometer and distance sensors are conveyed to close feedback loops onboard IC1, for continual monitoring of the speed of the equipment user, and the distance the equipment's bar makes with ground in the case of bench press. Likewise for the distance the metal sheet of the hack slide which the feet push back and forth also makes with the ground. When the difference between both positive and negative signals of the accelerometer's output is equal or above a certain value determined experimentally, and set by the values of the resistors and the input voltage in the difference amplifier in the conditioning circuit, the current system takes over to prevent accidents. Similarly, the emergency break is also triggered if the user of these equipments forgets to set the wedge on the bench. The position sensor will measure this special height when the bar of bench press is below the wedge level or the metal sheet of the hack slide is too close (distance determined experimentally) to the ground for a time frame sets experimentally. Specifically, IC1 in the servo system will process all the sensor signals through its A/D conversion. The Sigma-Delta technique converters are known as ideal for higher resolution. The main components of a first-order Sigma-Delta ADC are shown in FIG. 6. They are a modulator, a digital low pass filter and a decimation filter. The modulator consists of an integrator, a comparator, and 1-bit D/A converter feedback loop. The difference between the analog input signal and the output of 1-bit DAC is applied to the integrator. When the integrator's output voltage equals the comparator reference voltage, the comparator output switches from high to low or vice versa, depending on its original state. The comparator output is clocked into both the 1-bit DAC and the digital filter stage. When the comparator changes its state, the 1-bit DAC changes its analog voltage to the difference amplifier on the next clock pulse. This in turn changes the output voltage of the difference amplifier, causing the integrator output to change in the opposite direction. The modulator samples the analog input at a frequency many times the Nyquist rate equation and converts the signal into a binary weighted digital output. The digital filter uses an oversampling and averaging algorithm to achieve higher resolution. The combination of the digital filter and decimation filters stages also remove out of the band quantization errors and reduces the sample rate and the amount of data for subsequent transmission, and the oversampling rates used reduce antialiasing requirements considerably. State-of-the art Sigma and Delta contains a programmable gain amplifier, a multiorder Sigma and Delta converter, a calibration microcontroller with on-chip static RAM, a clock oscillator, a programmable digital filter, a bidirectional serial communications port.

Also, in relation with the sample frequency, the clock pulse should be 2 MHz, and every clock connected. The conversion time consists of two phases. In the first phase, the input sample is transferred to the Analog to Digital (ATD) node via the buffer amplifier in two ATD clock cycles. In the second phase, the ATD places the external analog signal onto the storage node for final charging and increased accuracy. The second phase takes 2, 4, 8 or 16 clock cycles if the coded value in the sample {1:0}, bits in the ATD register is respectively 00, 01, 10, or 11.

The ATD clock may further be divided by a prescale (PRS) value between 2 and 128, depending on the value settings of the PRS [4:0], prescale select, bits in the ATD register of IC1. For a prescale PRS[4:0] code between 0000 and 1111, the prescale setting is between 1 and 32, respectively. The frequency of the ATD clock is determined by dividing the bus frequency by [PRS+1]×2. The allowable ECLK frequency is ([PRS+1]×2/2<ECLK<([PRS+1]×2×2) MHz the PRS value out of a reset is 5, dividing the system bus (ECLK by 12, for an allowable range of 6<ECLK<MHz. If the nominal bus frequency is 16 MHz, the default ATD clock frequency is 4/3 MHz for a period of 750 ns. However, 2<ATDclock<5 MHz. If the ADT clock is slower than 5 KHZ, charge leakage in the converter begins to affect the conversion accuracy.

These sensor data are stored in IC1 of the servo system, but IC1 communicates with IC2 which controls the step motor to bring these exercise equipments to rest. The stepper is activated to stop the training when the difference between the accelerometer output signals has a certain value which is determined experimentally. This break is also activated when the position sensor output has a certain value for a time sets experimentally. This value is a distance measured experimentally from a reference point (ground, one upper bar of the bench press) to a point on the bench press's bar during exercise, or the distance measured from the metal sheet (sheet the feet push back and forth) of the hack slide to the ground. Specifically this distance is taken to be the height from the bar to the reference point when the bar is below the wedge level in the case of the bench press, or when the sheet metal of the hack slide is too close to the ground for some time set experimentally. Moreover, the internal feature of the selected IC2 should be able to bring these machines to rest over three different time intervals determined by the trapezoidal velocity profile, and the first time interval t₁ is when the motor provides enough torque that is, the right percentage of PWM to block these exercise equipments.

At the second time interval t₂ IC2 will automatically monitor the lifting of bars of the machine of interest while comparing every “command position” of IC2 with “actual position” of IC2. It is worth mentioning that the command position is the distance sensor measured heights of the bar, plates suspended to cable (cross over rope, and lap pull down) with respect to ceiling, one of these equipment's top plate, ground on an personalized exercised equipment. Specifically, the quadrature counts of the encoder onboard IC2 of the servo system provides the computer program with the actual distance of the bar, plates suspended to cable etc. A stepper DC motor continues to raise them with the appropriate percentage of PWM from IC2 which relates the weight sensor output to the motor torque until the actual position IC2 is equal or greater than the command position (distance senor's data) in IC2. That amount of the PWM is function of the weight sensor data, since to have equilibrium without any friction, the forces in presence should be equal and opposite in the direction of motion (Newton law). This principle will be used to program the servo system to provide the right amount of torque to block the load, and then gradually increase the torque till the final position is reached. We note that IC2 communicating with IC1 stores the weight sensor's data in one of its registers.

In the case of the semi manual bench press, when the final height of a bar is reached, at a particular clock cycle, the PMW from the IC2 provides the actuator 1 which is a smart bore (programmable) the necessary voltage to rotate the bar counter clockwise so that at the third time interval of the trapezoidal velocity profile, the motor safely releases the load (bench press's bar).

More importantly, there will be an emergency button to inhibit the system if something goes wrong with the control system itself, and so should it be another button for manual operation of the entire system

While the above description contains much specificity, these should not be construed as limitations on the scope of the invention, but rather as an exemplification of one preferred embodiment thereof. Many other variations are possible such as, but not limited to, those described in the cases above. Thus, the scope of the invention should be determined by the appended claims and their legal equivalents, rather than by the principal embodiment and other examples described above.

Examples of Calculus:

The present invention combines various calculations. Some formulae will be in the appendix, while others (amplifier selection, motor, resistor choices for the conditional circuit will be highlighted in this section)

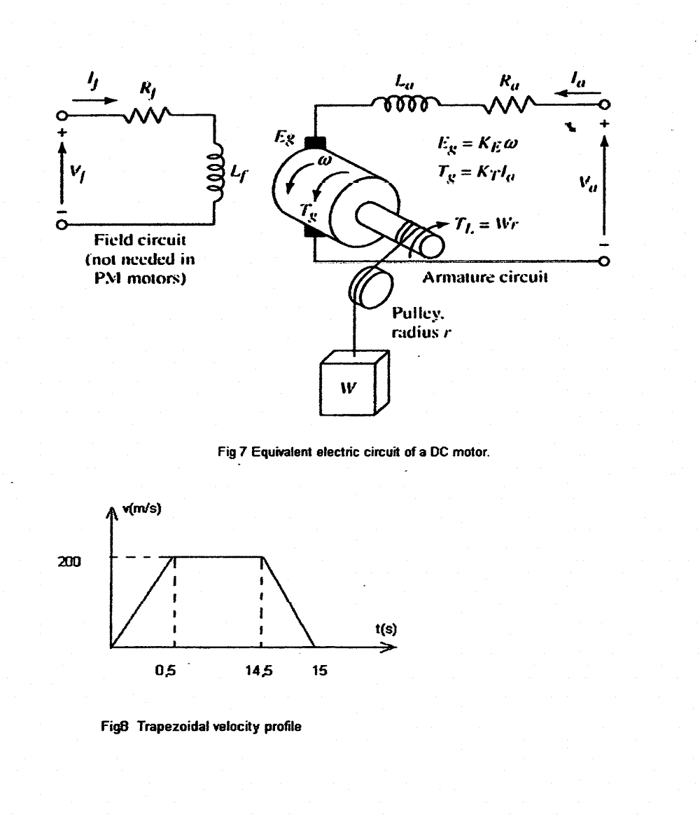

I—Inertia and Torque Selection for Pulley Motor System See FIG. 7

We know from the modeling of Dc Motor behavior in an electric circuit with a pulley that:

The motor-generated torque T_{g} is linearly related to the armature current Iₐ by:

Tg=K_{T}Iₐ

K_{T}: Torque constant of the motor and is given by

$${K}_{T} = \frac{{z}_{p}}{2 π n} ∅$$

ø is the radial magnetic flux, n′ is the number is parallel conductor paths in the armature and is the number of conductors moving through the magnetic field.

The generated torque can also be related to the power supplied to the motor.

Power is evaluated

$$P = {V}_{a} {I}_{a} = \frac{Ra}{Kt} Tg \times \frac{Tg}{{K}_{T}} = \frac{Ra}{{K}_{T}^{2}} {T}_{g}^{2}$$

$$Also$$

$$Tg = {K}_{M} \sqrt{ } P$$

Where K_{M} is given by:

$${K}_{M} = \frac{{K}_{T}}{\sqrt{{R}_{a}}}$$

K_{M} is the motor constant.

Also the analysis of the same circuit leads to the electric model of a DC motor;

$${V}_{a} = \frac{{L}_{a} d {I}_{a}}{dt} {}_{+}^{}{R}{}_{a}^{} {I}_{a} + Eg$$

Lₐ is the armature of inductance. Since the resistance due to magnetic circuit losses is usually 5-10 times greater than Ra and its effect on the motor is insignificant, so it is neglected. Additionally, the effect of La (very small)

Va reduces to

Vₐ=RₐIₐ+K_{E}ω

The equation is valid at constant load that is, when

$$\frac{d {I}_{a}}{dt}$$

is constant.

K_{T}, K_{E} are constant that depend on the magnetic field, geometry of air gap armature and constant construction. Depending on the system both are related as follows:

K_{T}(N−M/A)=9.5493×10⁻³ K_{E} (V/Krpm)

K_{T}(N−M/A)=K_{E} (V/Krpm)

Ra is the armature resistance, Va: Voltage applied to the armature.

This leads us to torque inertia calculation and the amplification selection.

Torque Inertia Selection

The pulley and load are to be accelerated from rest to 1.016 m/s in 0.5 s, driven during constant speed for 14 s and decelerate to rest in 0.5 s. the friction torque should be T._{f}=54.23 N. m. the choice is the motor comes down to the determination of the RMS.

We proceed to determine the total inertia J_{T} sees by the motor. In our DC motor pulley case, (FIG. 7 and FIG. 8)

$${J}_{T} = {J}_{1} + \frac{W}{g {N}^{2}} {r}_{p}^{2} + \frac{1}{2 {N}^{2}} {M}_{p} {r}_{p}^{2}$$

J₁ and N being respectively the gear reducer moment of inertia and number

The Load torque during the acceleration phase (t1:t≤0.5 s) is

$$\begin{matrix}{T}_{1} = {T}_{a} + {T}_{LF} \\ = {J}_{T} \frac{{ω}_{0}}{{t}_{1}} + \frac{{T}_{LF}^{′}}{N}\end{matrix}$$

$${T}_{1} = {J}_{T} \frac{v}{{t}_{1} rp} N + \frac{{T}_{LF}^{′}}{N}$$

Load torque during constant-velocity phase (T₂:≤t≤14.4 s) is the friction torque.

$${T}_{2} = \frac{{T}_{LF}^{′}}{N}$$

Load torque during deceleration phase (t₁:t≥14.5 s)

T₃=Tₐ−T_{LF}

Finally the RMS load torque is then

$${T}_{RMS} = √ \frac{{\sum }_{1}^{3} {T}_{i}^{2} {t}_{i}}{{\sum }_{i}^{3} {t}_{i}}$$

M: load mass

W: weight, g is the gravity

Amplifier Selection:

Considering that our Dc motor has a momentum of inertia J_{M}=10⁻⁴ kg−m², a resistance Ra=2Ω, and a constant torque K_{T}=0.2 Nm/A, the moment of inertia of the load is: J_{L}=2×10⁻⁴ Kg×m². The load is to be accelerated at

$$α = 10 \frac{rad}{{s}^{2}}$$

to reach a slew velocity of

$$ω = 100 \frac{rad}{s}$$

again a friction load of T_{f}=0.4 Nm.

Selecting amplifier size for a given application requires knowledge of the peak value for the motor's current and voltage. The peak current is determine by

$${I}_{MAX} = \frac{{T}_{PEAK}}{{K}_{T}}$$

where

$${T}_{PEAK} = {T}_{f} + {T}_{L} + {T}_{D} + {J}_{T} \frac{d ω}{d t} + {T}_{gr}$$

for the acceleration interval.
T_{f} is a constant coulomb friction torque, T_{D} is the viscous and friction torques, which are proportional to ω, and T_{gr} is a gravity torque.

Neglecting damping, the required in the expression of the peak torque, T_{D} is dropped.

Meanwhile, the peak voltage is obtained by substituting ω=ω_{MAX} and Iₐ=I_{MAX} in Vₐ=RₐIₐ+K_{E}ω so that we have,

Vₐ=RₐIₐ+K_{E} ω

V_{PEAK}=K_{T}ω_{MAX}+RₐI_{MAX}

Once the numerical application is carried out, the amplifier must be able to deliver I_{MAX} at V_{PEAK}. Since the system parameters may vary, a 25% margin on the amplifier rating is recommended.

The choice of a power MOSFET seems attractive, because it simplifies the cooling requirements and may eliminate the need for a fan.

II—Electrical Calculus.

Pulse-Width Modulation (PWM)

A PWM waveform is shown in FIG. 9. The duty cycle is the ratio of the time the signal is high (T_{H}) to the period of one cycle. PWM is a simple form of digital-to-analog conversion (DAC) used to obtain a high-resolution control of a slowly changing variable. A PWM output from a microcontroller can drive a DC motor. The duty cycle correlates to percentage of time the power is delivered to the DC motor. If the supply voltage to the coil is Vs, the average DC value of the output voltage is proportional to the duty cycle according to

$${V}_{DC} = {V}_{S} \times ( duty cycle ) = {V}_{S} \times \frac{{T}_{H}}{T}$$

The period T of the output waveform of this application can be very long, on the order of 0.1 s, relative to the period of the microcontroller clock. However, PWM can also be used in applications that require fast-switching control, such as controlling the speed and position of stepper and DC motors.

Selection of a Sensor From Offset, Span, and Resolution of ADC:

When for example a temperature sensor with a gain of 10 mV/° C. is used to measure the temperature of a process within the range of −50 to +200° C. An 8 bit ADC with a range from −5 to +5V is used. A signal conditioning is needed to match the limits of the sensor output vₛ with the input voltage vᵢ the ADC.

The range of the senor outputs for the temperature range of interest is −0.5V≤Vₛ≤+2V.

The sensor voltage Vs is related to the input voltage to the ADC by vₛ=mvᵢ+b, where m is the slope and b is the intercept. Applying corresponding voltage limits gives the two equations −0.5 m+b=−5 V and 2.0 m+b=+5V. Solving these two simultaneously yields m and b. The final relation is Vₛ=4vᵢ−3

The voltage and temperature offset and full scale are, respectively, (−5.0V, −50° C.) and (10V, 250° C.). The resolution in terms of the ADC output is

$${V}_{Q} = \frac{FS}{{2}^{k} - 1} ( N \text{/} {m}^{2} )$$

FS=x_{MAX}−x_{MIN}, with x being the input signal
k: output code bits
V_{Q}

We calculate the output voltage when the temperature T=50.

This is an example of calculation involves in determining:

a linear relationship a linear relationship for the signal conditioning circuit between vs and vi.

The offset, full scale, and resolution of the measurement in terms of voltage and temperature.

The output of the A/D if the temperature is +50° C.

Setting up Values of Component for the Conditioning Circuits

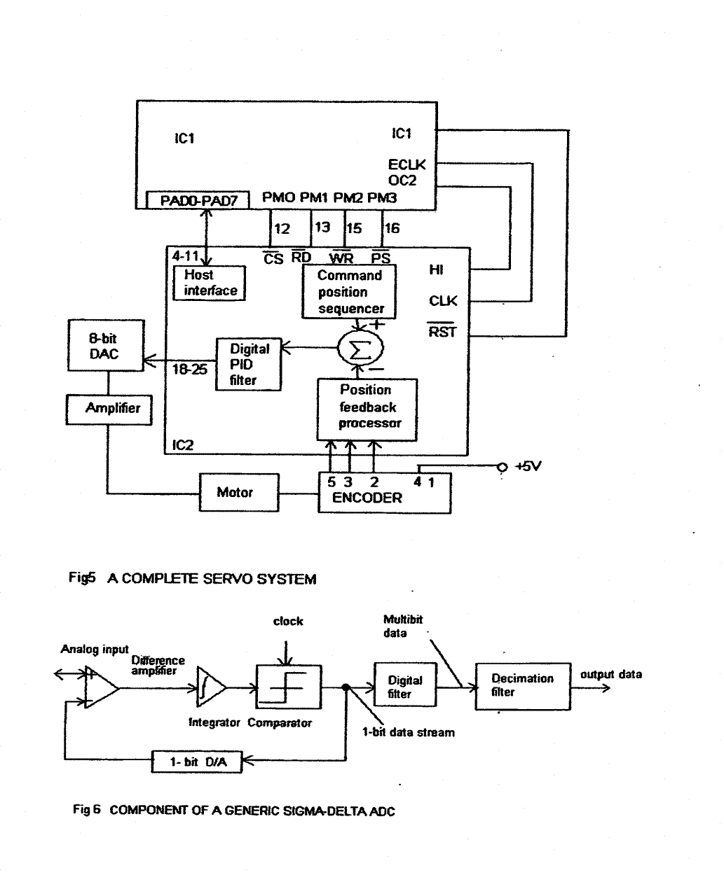

For the Accelerometer (FIG. 4)

Basically, all op-amps are “Differential Amplifiers” due to their input configuration. But by connecting one voltage signal onto one input terminal and another voltage signal onto the other input terminal the resultant output voltage will be proportional to the “Difference” between the two input voltage signals of V1 and V2.

Then differential amplifiers amplify the difference between two voltages making this type of operational amplifier circuit a Subtractor unlike a summing amplifier which adds or sums together the input voltages. This type of operational amplifier circuit is commonly known as a Differential Amplifier configuration and is shown below:

By connecting each input in turn to 0 v ground we can use superposition to solve for the output voltage Vout. Then the transfer function for a Differential Amplifier circuit is given as:

$${I}_{1} = \frac{{V}_{1} - {V}_{a}}{{R}_{1}} , {I}_{2} = \frac{{V}_{2} - {V}_{b}}{{R}_{2}} , {I}_{f} = \frac{{V}_{a} - ( {V}_{out} )}{{R}_{3}}$$

Summing point Vₐ=V_{b}

and

$${V}_{b} = {V}_{2} ( \frac{{R}_{4}}{{R}_{2} + {R}_{4}} )$$

If V_{b}=0, then:

$${V}_{out ( a )} = - {V}_{1} ( \frac{{R}_{3}}{{R}_{1}} )$$

If Vₐ=0, then:

$${V}_{out ( b )} = {V}_{2} ( \frac{{R}_{4}}{{R}_{2} + {R}_{4}} ) ( \frac{{R}_{1} + {R}_{3}}{{R}_{1}} )$$

$${V}_{out} = {V}_{out ( a )} + {V}_{out ( b )} \\ ∴ {V}_{out} = - {V}_{1} ( \frac{{R}_{3}}{{R}_{1}} ) + {V}_{2} ( \frac{{R}_{4}}{{R}_{2} + {R}_{4}} ) ( \frac{{R}_{1} + {R}_{3}}{{R}_{1}} )$$

When resistors, R1=R2 and R3=R4 the above transfer function for the differential amplifier can be simplified to the following expression:

Differential Amplifier Equation

$${V}_{OUT} = \frac{{R}_{3}}{{R}_{1}} ( {V}_{2} - {V}_{1} )$$

If all the resistors are all of the same ohmic value, that is: R1=R2=R3=R4 then the circuit will become a Unity Gain Differential Amplifier and the voltage gain of the amplifier will be exactly one or unity. Then the output expression would simply be Vout=V2−V1. Also note that if input V1 is higher than input V2 the output voltage sum will be negative, and if V2 is higher than V1, the output voltage sum will be positive.

If V1 is a certain experimental value of V2, Vout trigger the Control system to take control of the system.

The instrumentation amplifier in the conditioning circuit of the weight sensor (FIG. 2)

Instrumentation Amplifiers (in-amps) are very high gain differential amplifiers which have high input impedance and a single ended output. Instrumentation amplifiers are mainly used to amplify very small differential signals from strain gauges, thermocouples or current sensing devices in motor control systems.

Unlike standard operational amplifiers in which their closed-loop gain is determined by an external resistive feedback connected between their output terminal and one input terminal, either positive or negative, “instrumentation amplifiers” have an internal feedback resistor that is effectively isolated from its input terminals as the input signal is applied across two differential inputs, V1 and V2.

The instrumentation amplifier also has a very good common mode rejection ratio, CMRR (zero output when V1=V2) well in excess of 100 dB at DC.

The two non-inverting amplifiers form a differential input stage acting as buffer amplifiers with a gain of 1+2R2/R1 for differential input signals and unity gain for common mode input signals. Since amplifiers A1 and A2 are closed loop negative feedback amplifiers, we can expect the voltage at Vₐ to be equal to the input voltage V1. Likewise, the voltage at V_{b} to be equal to the value at V2.

As the op-amps take no current at their input terminals (virtual earth), the same current must flow through the three resistor network of R2, R1 and R2 connected across the op-amp outputs. This means then that the voltage on the upper end of R1 will be equal to V1 and the voltage at the lower end of R1 to be equal to V2. This produces a voltage drop across resistor R1 which is equal to the voltage difference between inputs V1 and V2, the differential input voltage, because the voltage at the summing junction of each amplifier, Vₐ and V_{b} is equal to the voltage applied to its positive inputs.

However, if a common-mode voltage is applied to the amplifiers inputs, the voltages on each side of R1 will be equal, and no current will flow through this resistor. Since no current flows through R1 (nor, therefore, through both R2 resistors, amplifiers A1 and A2 will operate as unity-gain followers (buffers). Since the input voltage at the outputs of amplifiers A1 and A2 appears differentially across the three resistor network, the differential gain of the circuit can be varied by just changing the value of R1.

The voltage output from the differential op-amp A3 acting as a subtractor, is simply the difference between its two inputs (V2−V1) and which is amplified by the gain of A3 which may be one, unity, (assuming that R3=R4). Then we have a general expression for overall voltage gain of the instrumentation amplifier circuit as:

Instrumentation Amplifier Equation

$${V}_{OUT} = ( {V}_{2} - {V}_{1} ) [ 1 + \frac{2 {R}_{2}}{{R}_{1}} ] ( \frac{{R}_{4}}{{R}_{3}} )$$

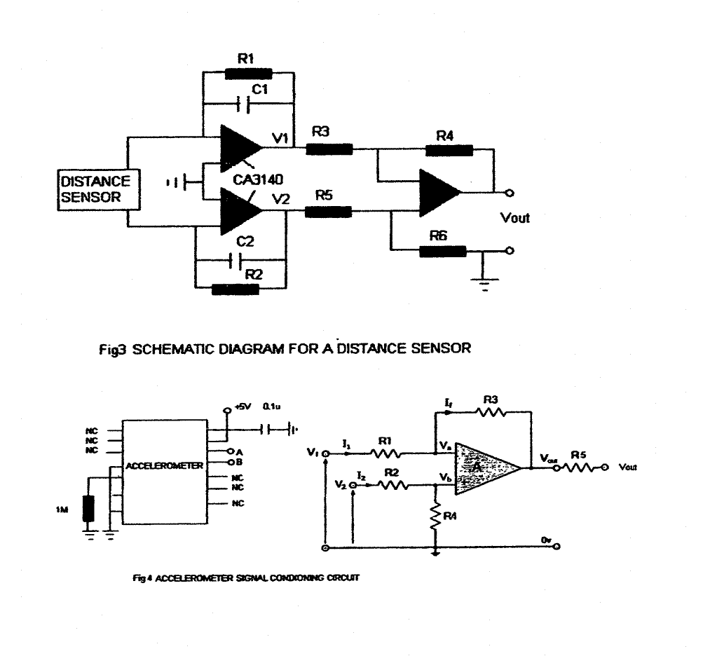

Similar pattern of calculation applies to the conditioning circuit of the distant sensor (FIG. 3).

Stepper Motor Performance

Single-Step Operation

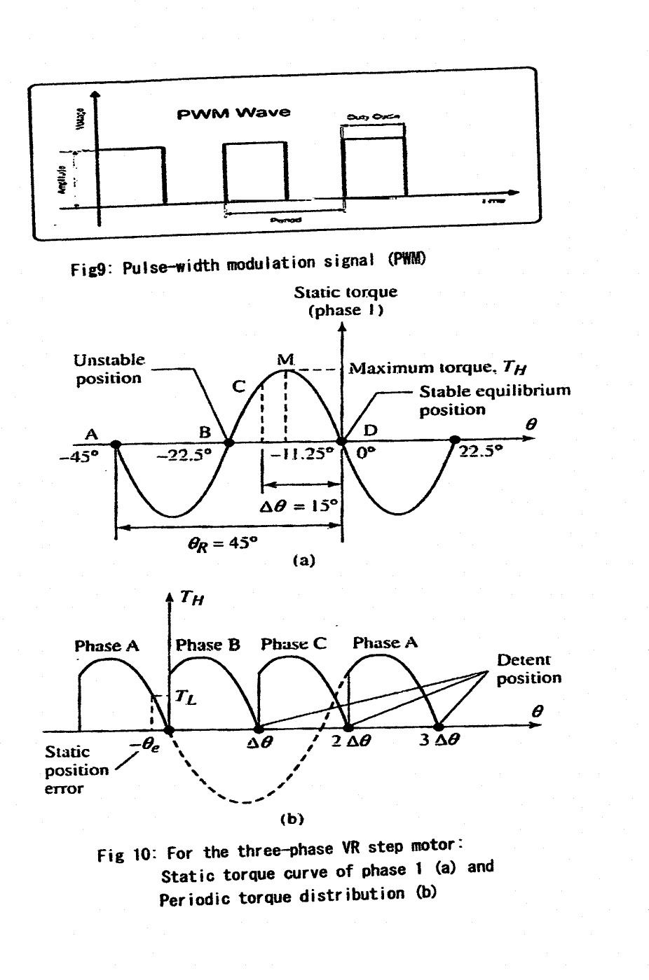

The static torque for one phase of the three-phase VR motor may be assumed to be a sinusoidal waveform, as shown in FIG. 10a. For a motor with pole=3, number of teeth of the stator ns=8, and a step angle of 15°. Point D is the detent position when phase A is being energized. If the rotor is rotated 15° CCW by external means to occupy position C, the previous detent position of the rotor before phase was energize, a positive torque would act on the rotor, trying to rotate it back to position D. Point A, corresponding to a position of 45° . . . which is a rotor pitch θ_{R}from point D, is also a detent point, but point B is unstable and a small torque would move the rotor in either direction. The torque at point C is positive but not maximum. The maximum torque, also called the holding torque T_{H}, occurs at point P corresponding to a rotor position 11.25° from point D. The static torque with maximum current applied to only one phase is expressed as

T=−T_{H} sin n_{R}θ==−T_{H} sin(2πθ/θ_{R}

For a motor with p phases, the static torque for each phase is periodic, with a period pΔθ=θ_{R}. This relation is shown in FIG. 10b for a three-phase VR motor. The static torque (at zero speed) in this case is expressed as

T=−T_{H} sin(2πθ/pΔθ

Which is valid in the range −Δθ≤θ≤0. If the motor windings are not energized, the torque required to rotate the stepper motor is called detent torque.

The detent position is attained if no static load is applied to the shaft. In case a static load −T_{L} is applied, the stator will deviate from the detent position by an angle θₑ, termed the static-position error. This error can be found by substituting T_{L} for T and θₑ, for θ in first previous Equation to yield

$${θ}_{e} = \frac{p Δθ}{2 π} {sin}^{- 1} ( {T}_{H} / {T}_{L} ) = \frac{p}{s} {sin}^{- 1} ( \frac{{T}_{L}}{{T}_{H}} )$$

Where is the number of steps per revolution, or step rate. It is clear that as s increases, θₑ decreases.

When a single step is applied to an energized phase, the rotor turns through the step angle θₒ. Before the rotor comes to rest at the end of the step, it oscillates about the new stable position, as shown 11. These oscillations are caused primarily by the load inertia, which can be expressed, when damping and friction effects are neglected, by the second-order relation

J\ddot{θ}=T

T: torque

The time it takes for the oscillations to subside is called the settling time tₛ, which is approximately equal to 4τ (τ is a time constant)

Slewing Operation

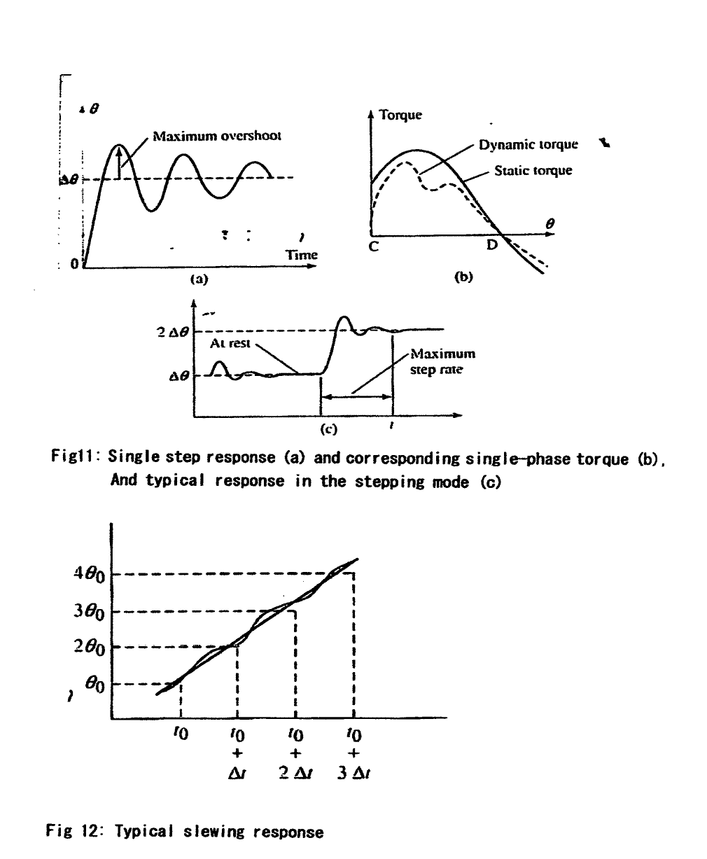

As the step rate increases, switching would be required before the rotor fully comes to rest in each step and the motion changes from discrete steps to a continuous motion, termed stewing motion. The time-displacement curve under steady-state slewing is shown in FIG. 12. The constant pulse rate S_{R}, or the slew rate (pulses/s), is expressed as

$${S}_{R} = \frac{1}{Δ t} ( \frac{steps}{s} )$$

Where Δt is the time between successive pulses. If Δt is smaller than the settler time tₛ, unavoidable periodic oscillations (or hunting) will result. The amplitude of these oscillations can be reduced by increasing damping. In addition, the upper limit of S_{R} depends on the inertia of the rotor and the load, the damping, and the load rating.

To drive the motor constant at a constant slew rate, the pulse is increased through accelerating the rotor from a lower speed by means of ramping. Assuming linear variation, the pulse rate increases according to

$${S}_{R} = {S}_{0} + \frac{( {S}_{R} - {S}_{0} ) t}{{t}_{o}}$$

Where S₀ is the starting pulse rate (typically zero), S_{R} is the final pulse rate, and t₀ is the ramp time (t₀=nΔt, n is the total number of pulses applied). The angular velocity of the motor, ω, is expressed in terms of S_{R}, as ω=ksS_{R} where

$$k = \frac{2 π rad \text{/} rev}{( 360 ° / Δ θ pulse \text{/} rev}$$

The operating angular velocity ω_{0P} should not fall within the band of resonant frequencies given by

$${ω}_{{N}_{1}} = \sqrt{ } \frac{360 {T}_{H}}{J Δ θ} , \\ {ω}_{{N}_{2}} = \sqrt{ } \frac{720 {T}_{H}}{π J Δ θ} ,$$

Thus ω_{0P} should be ω_{0P}<ω_{N}_{₁} or ω_{0P}>ω_{N2} to avoid resonance and missed steps from occurring.

Microstepping

A microstepper may be driven such that each fundamental step Δθ is divided into a number of mini- or microsteps. Microstepping is accomplished by changing the phase currents incrementally in steps so that the currents in two adjacent motor phases are balances, to force the rotor to assume a desired angular position between two adjacent stator poles. The vector sum of the magnetic fields generated in the adjacent phase windings defines the angular position along which the rotor will align. This driving approach improves the positional resolution of the motor, eliminates ripple in the output torque, and provides for an operating frequency that is higher than the resonant frequencies of the motor. However, the equilibrium points are not as well defined.

Dynamic Behavior

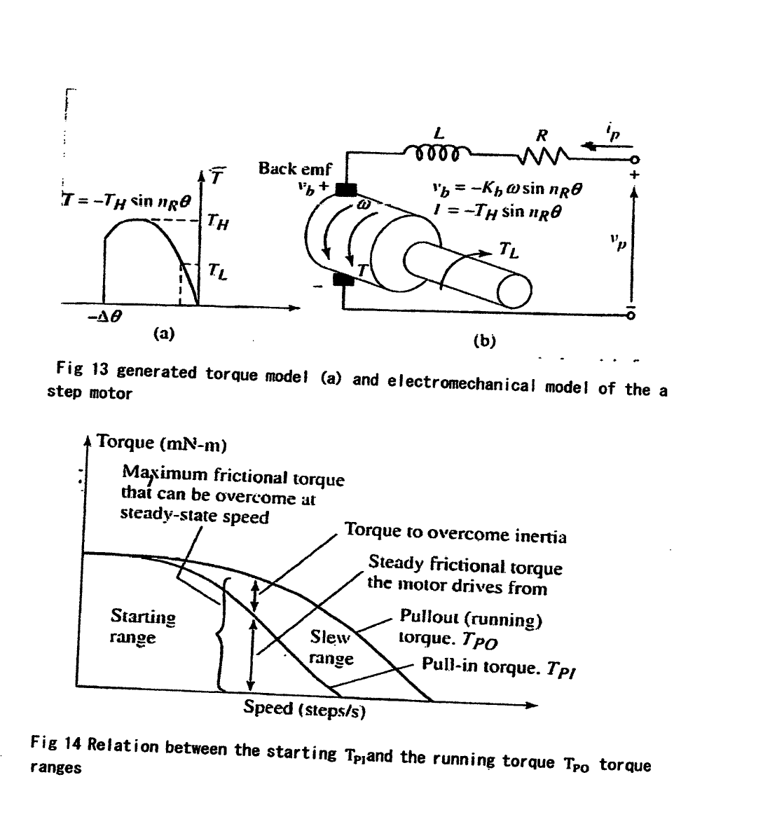

FIG. 13 shows a model of a stepper motor connected to a load. The dynamic motion of the rotor is governed by

$$( {J}_{M} + {J}_{L} ) \frac{d ω}{st} = {T}_{a} + {T}_{b} - B ω - {T}_{L} ,$$

J_{M} i s the inertia of the rotor, J_{L} is the load inertia, B is the coefficient of viscous damping, T_{L}, is the load torque, which may include coulomb, friction torque and gravitional torque, and ω is the angular velocity of the rotor. The electromagnetic torques Tₐ and T_{b} generated by phases P-A and P-B are given by:

Tₐ=(−K_{w} sin θ)Iₐ(t)

T_{b}=(Kₑ cos θ)Iₐ(t)

A plot of steady torque output vs speed is shown in FIG. 13. The plot outlines the regions in which the motor torque operates correctly. The holding torque is generated at standstill. As the step rate increases, phase switching takes place before the current in the inductor reaches its steady-state value and the torque decreases.

FIG. 14 features two curves. The pull-in torque c, or start-without-error torque, and the pull out torque T_{Po}, or running torque. Pull-in torque is the maximum torque the motor can produce starting from rest (or stop without loss of a step) and accelerating to operate at a given step rate. Since it includes the torque required to overcome rotor inertia, the pull-in torque represents the torque required to overcome constant friction and gravity torques.

Once the rotor reaches the steady-state speed, the acceleration becomes zero and no torque is needed to overcome inertia. The inertia torque will then be utilized to overcome friction and gravity torque. Pullout torque represents the maximum torque that overcomes inertia is the difference between the two curves. The region between the two curves is the skew range. If the friction and gravity torques is known and has a fixed value, its intersection with the pull-in torque curve gives the maximum step rate at which the motor can run while moving the load from rest, and its intersection with the pullout torque curve give the maximum step rate possible after the motor reaches the pull-in step rate.

Another point of concern is that while the pullout torque curve is the same for any load inertia, the pull-in torque at a given speed is

$${T}_{PI} ( {J}_{L} \neq 0 ) = \frac{{J}_{L}}{{J}_{M}} {T}_{PI} ( {J}_{L} = 0 )$$

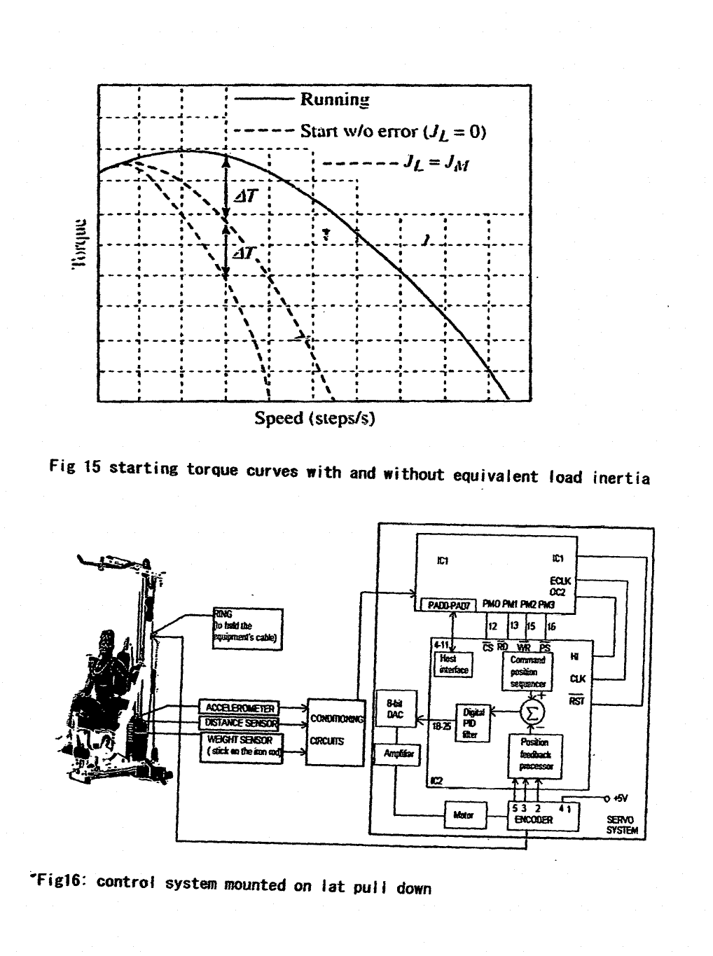

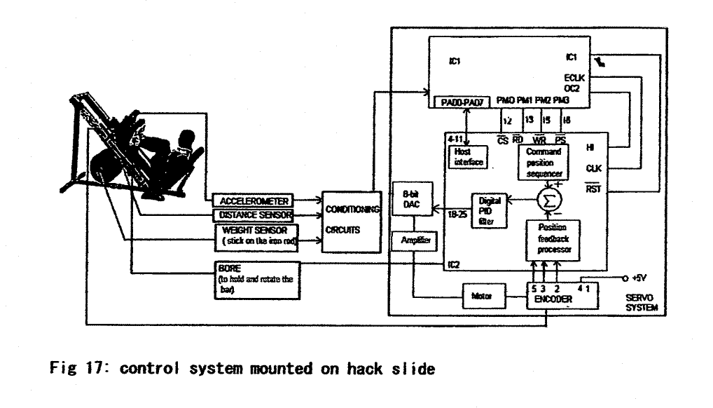

FIG. 15 shows the pull-in torque with J_{L}=J_{M} compared to that with J_{M}=0. Note that the distance between the curves at a given speed is the same J_{L}=J_{M}.

### INDUSTRIAL APPLICABILITY

The invention can be applied to gymnasium equipments such as bench press, cross-over rope, leg press, chest press, lat pull down and so on. . . .

### REFERENCE SIGNS LIST

1—www.agilent.com for the IC2 (HCTL-1101 and www.freescale for IC1.
2—Applied mechatronics by A. Smaili and F. Mrad
3—Automatic control systems by Farid and Benjamin C. Kuo
4—Sensors selection
5—http://www.hokuyo-aut.jp/02sensor/04freepower/plx.html
6—distance sensor
7—http://www.directindustry.com/prod/bernstein/ultrasonic-distance-sensors-15137-462022.html
8—shop.di-soric.de/en/Ultrasonic-Sensors-20101,1342.html?pdb_kategorie=1512
9—weight sensors
10—http://www.omega.com/toc_asp/subsectionSC.asp?subsection=F&book=Pressure&all=1
11—another weight sensor
12—http://www.tme-france.com/en/catalogue/detail/cat-2/tech-1/34-MFL+300-1200.htm
13—signal conditioning circuit for the weight sensor
14—http://japan.maximintegrated.com/app-notes/index.mvp/id/1069
15—capacitive sensor conditioning circuit
16—http://www.capsense.com/capsense-wp.pdf
17—http://www.electronics-tutorials.ws/opamp/opamp_5.html
18—http://www.site.uottawa.ca/˜smiah069/Courses/ELG4159-Winter2012-pt/lectures/part3/part3-main-print.pdf
19—
20—http://www.electronics-tutorials.ws/opamp/opamp_5.html
21—http://www.livestrong.com/article/429786-the-history-of-fitness-machines/

1. A control system for gymnasium equipments, said lat pull down, chin-dip assist, pec fly, hack slide, bench press, crossover rope comprises an accelerometer, a weight sensor, a distance sensors, a complete servo system and a piezoelectric bore for mechanical mounting on and beside said exercise equipments, the weight sensor will be stuck on that equipment's said metal rod to establish a contact in the hole of said plate of the apparatus, with the distance sensor placed on said upper part of the equipment and depending thereof, said chosen apparatus by the user, while said accelerometer is stuck on the moving part of said equipment, said either on the top plate of the chosen equipment, said a location or distant different from that of said weight sensor, a complete servo system enclosed in a body being adapted to be mounted close to the exercise equipment, said in a safe location, whereabouts said servo system's step motor lifts the target of said equipments from a convenient location, the piezoelectric bore is to establish a contact with said portion of the bench press's bar, the leg press's bar.

2. The control system of claim 1, wherein the operations include reading, storing said sensors data, processing them in the IC1 of said servo system, wherein said arithmetic operations take place.

3. The control system of claim 1, wherein the operations include storing the weight sensor data in IC2 through IC1, and use this information to calculate the right percentage of said PWM, with which the computer program selects said phase sequences of the step motor to trigger a break on said exercise equipments, thereby preventing accidents.

5. The control system of claim 1, wherein the computer program is written for desired operations of said servo system and sensors, being adapted to meet the expectations of said exercise equipments.

6. The control system of claim 1, wherein the position sensor measured heights said initial distant of said exercise equipment's bar with respect to a reference point, in particular the ground on which these equipments are fixed or one upper part of said equipments, said critical distance being defined from said reference point to the bar position said below safety wedge level of said bench's press, hack slide are carried to IC2 of said servos system via said IC1, wherein the initial position provides precise guidance of said level whereabouts the step motor is to lift the bar of said bench press, release the load of said crossover rope, hack slide.

7. The control system of claim 1, wherein the bore rotates the bar of said bench press after being raised to the position sensor's initial level chosen by the user of the exercise equipment, indicating said readiness of the stepper to finally release the bar.

8. The control system of claim 1, wherein the accelerometer has been conditioned to trigger the emergency break with its said output's voltage level.

9. The control system of claim 1, wherein said position sensor's particular output level triggers the emergency break when the accelerometer detection level fails.

10. The control system of claim 1, wherein the emergency button and a switch are respectively used for said sudden stop and manual monitoring of said servo system.
